(19) United States
(12) Patent Application Publication
(10) Pub. No.: US 2022/0244549 A1
(43) Pub. Date: Aug. 4, 2022

(54) ATTACHMENT AND HEAD-MOUNTED DISPLAY

(71) Applicant: SEIKO EPSON CORPORATION, Tokyo (JP)

(72) Inventor: Yoshihiro YOSHIMURA, Matsumoto-shi (JP)

(73) Assignee: SEIKO EPSON CORPORATION, Tokyo (JP)

(21) Appl. No.: 17/587,703

(22) Filed: Jan. 28, 2022

(30) Foreign Application Priority Data
Jan. 29, 2021 (JP) 2021-013648

(51) Int. Cl. G02B 27/01

(52) U.S. Cl. CPC G02B 27/0176; G02B 2027/0178; G02B 2027/0158; G02B 2027/0134; G02B 27/0172

(57) ABSTRACT

An attachment is an attachment for attaching a head-mounted display body including a display unit configured to display an image to a helmet to be mounted on a head, the attachment includes: a link plate configured to support the display unit in a predetermined posture, and a clip plate configured to attach the link plate to a helmet, and the link plate includes: a lower hinge shaft having a rotation axis thereof in a first direction, and an upper hinge shaft having a rotation axis thereof in the first direction, the link plate is configured to support an HMD body in a rotatable manner in a rotational direction about an axis of the lower hinge shaft in a predetermined posture, and the link plate is supported on the clip plate in a rotatable manner in the rotational direction about an axis of the upper hinge shaft in a predetermined posture.

The present application is based on, and claims priority from JP Application Serial Number 2021-013648, filed Jan. 29, 2021, the disclosure of which is hereby incorporated by reference herein in its entirety.

### BACKGROUND

### 1. Technical Field

The present disclosure relates to an attachment and a head-mounted display.

### 2. Related Art

Conventionally, there has been known a head-mounted display that is mounted on a head by way of an attachment object such as a helmet (for example, see JP-A-2018-195950). JP-A-2018-195950 discloses a video image display device including an attachment unit configured to be attached to a brim of a helmet, a display unit configured to display a video image, and a support unit configured to rotatably support the display unit and to be coupled to the attachment unit by a ball joint mechanism.

When the position of the display unit is fixed by the ball joint mechanism as disclosed in JP-A-2018-195950, the position of the display unit can be adjusted in various directions. On the other hand, when the video image display device is in use, the position of the display unit is liable to be displaced due to impacts from various directions.

### SUMMARY

An attachment according to one aspect of the present disclosure includes a support member that supports a display unit of a head-mounted display and that includes a first rotary shaft with a first direction as rotation axis and a second rotary shaft with the first direction as rotation axis; and an attachment unit that attaches the support member to an object, wherein the support member is configured to rotatably support the display unit by an axis of the first rotary shaft, and the support member is configured to rotatably support the attachment unit by an axis of the second rotary shaft.

According to another aspect of the present disclosure, there is provided a head-mounted display that includes: a display unit configured to display an image, a support member configured to support the display unit and including a first rotary shaft having a rotation axis thereof in a first direction and a second rotary shaft having a rotation axis thereof in the first direction, and an attachment unit configured to attach the support member to an object, wherein the support member is configured to rotatably support the display unit in a rotational direction about an axis of the first rotary shaft, and the support member is configured to be rotatably supported by the attachment unit in a rotational direction about an axis of the second rotary shaft.

### BRIEF DESCRIPTION OF THE DRAWINGS

FIG. 1 is a front view illustrating an in-use state of a head-mounted display according to a first embodiment.

FIG. 2 is a side view illustrating an in-use state of the head-mounted display according to the first embodiment.

FIG. 3 is a perspective view of the head-mounted display according to the first embodiment.

FIG. 4 is a cross-sectional view taken along a line IV-IV in FIG. 1.

FIG. 5 is a front view illustrating an in-use state of a head-mounted display according to a second embodiment.

### DESCRIPTION OF EXEMPLARY EMBODIMENTS

Hereinafter, preferred embodiments of the present disclosure are described in detail with reference to drawings. The embodiments described hereinafter are not intended to limit the content of the present disclosure set forth in the claims. Further, all of the configurations described hereinafter are not necessarily essential constituent requirements of the present disclosure.

### 1. First Embodiment

### 1-1. Entire Configuration of Head-Mounted Display

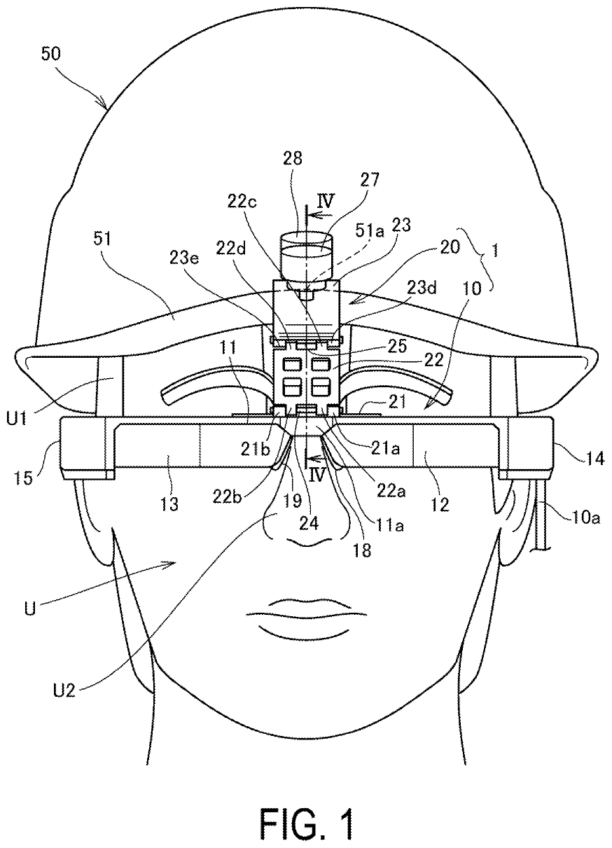

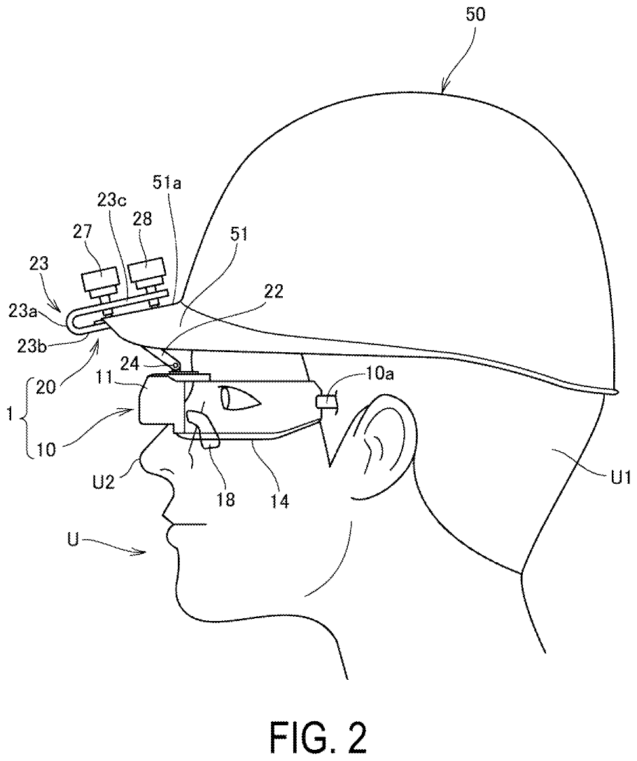

FIG. 1 is a front view illustrating an in-use state of a head-mounted display 1 according to a first embodiment. FIG. 2 is a side view illustrating an in-use state of the head-mounted display 1 according to the first embodiment. In FIG. 2, the head-mounted display 1 is illustrated in a state where the illustration of some parts is omitted.

Hereinafter, in the description of the present embodiment, front and rear, left and right, and up and down are determined in reference to a direction for a user U wearing the head-mounted display 1, illustrated in FIG. 1.

The head-mounted display 1 is a head-mounted display device or a so-called HMD that allows the user U to visually recognize a virtual image in a state where the head-mounted display 1 is mounted on a head U1 of the user U. The HMD is an abbreviation for Head Mounted Display. The head-mounted display 1 includes an HMD body 10 as an example of a display unit, and an attachment 20 configured to attach the HMD body 10 to a helmet 50. The helmet 50 corresponds to an example of an object to be mounted on the head U1. The HMD body 10 corresponds to a head-mounted display body.

The head-mounted display 1 includes a control device, not illustrated in the drawings, to which a cable 10a extending from a left side of the HMD body 10 of the head-mounted display 1 is wired. The control device not illustrated in the drawings includes various buttons and switches, a track pad, and the like for receiving an operation by the user U, and functions as a controller operated by the user U. The HMD body 10 of the head-mounted display 1 is controlled by the controller.

1-1-1. Configuration of HMD Body

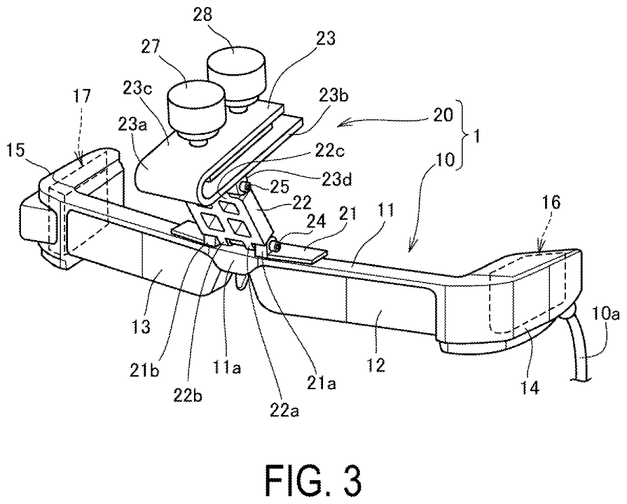

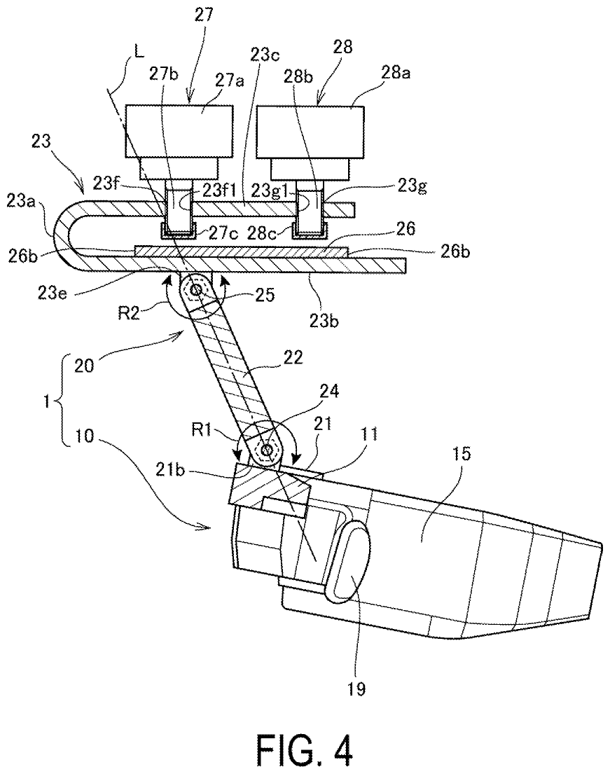

FIG. 3 is a perspective view of the head-mounted display 1 according to the first embodiment. FIG. 4 is a cross-sectional view taken along a line IV-IV in FIG. 1.

The head-mounted display 1 is an HMD for both eyes, and has an eyeglasses shape in appearance. The HMD body 10 of the head-mounted display 1 has a frame 11 extending in a left-and-right direction. The frame 11 corresponds to an example of a fixing member. To the frame 11, a left light-guiding plate 12 and a right light-guiding plate 13 are fixed as constitutional parts corresponding to a lens portion of the eyeglasses. The left light-guiding plate 12 is positioned in front of the left eye of the user U in a state where the user U wears the head-mounted display 1. The right light-guiding plate 13 is positioned in front of the right eye of the user U in a state where the user U wears the head-mounted display 1. The left light-guiding plate 12 corresponds to an example of a first display unit. The right light-guiding plate 13 corresponds to an example of a second display unit.

The left light-guiding plate 12 and the right light-guiding plate 13 are optical components such as prisms made of a resin having optical transparency or the like. As described later, the left and right light guiding plates 12, 13 are configured to allow the user to visually recognize an image by guiding an imaging light to the eyes of the user. Further, a dimming plate, not illustrated in the drawings, that functions as a wavelength filter may be provided on a surface of the left light-guiding plate 12 and a surface of the right light-guiding plate 13 respectively. In this case, by appropriately selecting an optical property of the light control plate, a transmittance of light within an arbitrary wavelength range such as visible light, infrared light, ultraviolet light, and the like can be adjusted. An amount of outside light that is incident on the left light-guiding plate 12 and the right light-guiding plate 13 from the outside and passes through the left light-guiding plate 12 and the right light-guiding plate 13 can be adjusted.

A left holding part 14 extending rearward is provided on a left end of the frame 11. In a state where the user U wears the head-mounted display 1, the left holding part 14 is provided so as to extend from the left end of the frame 11 to the position corresponding to a left side of the head of the user U. In the present embodiment, the left holding part 14 is configured to have a length that allows the left holding part 14 to extend to an area near a temple but does not allow the left holding part 14 to reach a left ear. A left display device 16 is provided inside the left holding part 14. The left display device 16 corresponds to an example of the first display device.

The left display device 16 emits imaging light for the left eye. The left display device 16 includes an optical system, not illustrated in the drawings, and is configured to guide imaging light for the left eye to the left light-guiding plate 12 by the optical system not illustrated in the drawings. In the left light-guiding plate 12, external light from a front side and imaging light for the left eye are incident on the left eye by a half mirror not illustrated in the drawings.

A right holding part 15 extending rearward is provided on a right end of the frame 11. In a state where the user U wears the head-mounted display 1, the right holding part 15 is provided so as to extend from the right end of the frame 11 to a position corresponding to a right side of the head of the user U. In the present embodiment, the right holding part 15 is configured to be substantially in left-right symmetry with the left holding part 14. A right display device 17 is provided inside the right holding part 15. The right display device 17 corresponds to an example of the second display device.

The right display device 17 emits imaging light for the right eye. The right display device 17 includes an optical system, not illustrated in the drawings, and is configured to guide imaging light for the right eye to the right light-guiding plate 13 by the optical system not illustrated in the drawings. In the right light-guiding plate 13, external light from a front side and imaging light for the right eye are incident on the right eye by a half mirror not illustrated in the drawings.

As described above, the HMD body 10 allows image light of an image processed in the inside of the HMD body 10 and external light to be incident on the eyes of the user U in a superposed manner. Accordingly, the user U can observe an outside scene through the left light guiding plate 12 and the right light guiding plate 13, and the user U can visually recognize the image formed by the imaging light in a state where the image formed by the imaging light is superposed on the outside scene.

The frame 11 has a coupling portion 11a corresponding to a gap between the left light-guiding plate 12 and the right light-guiding plate 13. As illustrated in FIG. 1, the coupling portion 11a corresponds to an area in a vicinity of the glabella of the user U in a state where the user U wears the head-mounted display 1.

To the coupling portion 11a of the frame 11, a pair of left and right nose pads 18, 19 configured to be brought into contact with a nose U2 of the user U, in a state where the user U wears the head-mounted display 1, is provided. The nose pads 18, 19 are respectively made of a resin. As illustrated in FIG. 1 and FIG. 2, in the present embodiment, the nose pads 18, 19 are disposed such that the nose pads 18, 19 can approach and can be separated from the nose U2 of the user U. In FIG. 2, with respect to the left holding part 14 of the head-mounted display 1, only a portion of the left holding part 14 is illustrated. That is, FIG. 2 is illustrated such that the positional relationship between the left holding part 14, the nose pad 18, and the nose U2 of the user U can be understood. In the present embodiment, the nose pads 18, 19 are members for suppressing an impact generated when the head-mounted display 1 hits the user U. Further, the nose pads 18, 19 may be configured to be brought into contact with the nose U2 so that the head-mounted display 1 may be supported by the nose pads 18, 19.

In the present embodiment, the nose pads 18, 19 are detachably supported on the frame 11. Accordingly, the user U can mount the nose pads 18, 19 on the frame 11 or can omit mounting of the nose pads 18, 19 on the frame 11 in accordance with the preference of the user U. By omitting the nose pads 18, 19, it is possible to prevent the nose pads 18, 19 that form protruding portions from being brought into contact with the nose U2 due to vibrations during walking, for example. Accordingly, it is possible to prevent a user U from having a feeling of discomfort.

Here, the left-and-right direction of the head-mounted display 1 corresponds to a direction that the first display unit and the second display unit are aligned, that is, in the present embodiment, a direction that the left light-guiding plate 12 and the right light-guiding plate 13 are aligned. A fore-and-aft direction of the head-mounted display 1 corresponds to a direction that the imaging light is emitted from the light-guiding plates 12, 13 toward the eyes of the user U. A vertical direction of the head-mounted display 1 corresponds to a direction orthogonal to the left-and-right direction and the fore-and-aft direction of the head-mounted display 1.

1-1-2. Configuration of Attachment

The HMD body 10 of the head-mounted display 1 is attached to the helmet 50 by way of the attachment 20.

The attachment 20 has a fixing portion 21 fixed to the HMD body 10, a link plate 22 that rotatably supports the fixing portion 21, and a clip plate 23 for attaching the link plate 22 to the helmet 50. The link plate 22 corresponds to an example of the support member. The clip plate 23 corresponds to an example of the attachment unit.

The fixing portion 21 is formed in a plate shape extending in the left-and-right direction. The fixing portion 21 is fixed to an upper surface of the frame 11 of the HMD body 10. The fixing portion 21 is fixed corresponding to the coupling portion 11a. That is, the fixing portion 21 is fixed to a center portion of the HMD body 10 in the left-and-right direction. With such a configuration, the positional relationship between the fixing portion 21 and the left light-guiding plate 12 and the positional relationship between the fixing portion 21 and the right light-guiding plate 13 can be made equal. Accordingly, the adjustment of the head-mounted display 1 at the time of attaching the head-mounted display 1 to the helmet 50 can be performed easily. The fixing portion 21 is fixed to the upper surface of the frame 11 using a double-sided tape, not illustrated in the drawings, for example. The fixing portion 21 may be fixed to the upper surface of the frame 11 by threaded engagement in place of using the double-sided tape. As the fixing method of the fixing portion 21, an arbitrary method can be adopted. However, it is desirable that the fixing portion 21 can be repeatedly fixed to the frame 11. Accordingly, for example, another functional attachment for direct attachment to the head U1 can be attached to the HMD body 10 in an exchangeable manner.

On an upper surface of the fixing portion 21, a pair of left and right shaft support portions 21a, 21b protruding upward are formed. A through hole, not illustrated in the drawings, penetrating in the left-and-right direction is formed in the shaft support portions 21a, 21b respectively, and a lower hinge shaft 24 extending in the left-and-right direction is inserted through the through holes. The left-and-right direction, that is, a width direction of the user's face corresponds to an example of the first direction. The lower hinge shaft 24 corresponds to an example of the first rotary shaft.

The link plate 22 is supported on the lower hinge shaft 24 in a rotatable manner about the lower hinge shaft 24. The link plate 22 has a flat plate shape extending in a direction L orthogonal to the left-and-right direction. On one end of the link plate 22 in a longitudinal direction L, a pair of left and right shaft support portions 22a, 22b protruding in the longitudinal direction L is formed. A through hole, not illustrated in the drawings, penetrating in the left-and-right direction is formed in the shaft support portions 22a, 22b respectively. The shaft support portions 22a, 22b are disposed inside the shaft support portions 21a, 21b of the fixing portion 21 in the left-and-right direction, and the lower hinge shaft 24 is inserted through the through holes. With such a configuration, the link plate 22 rotates in a rotational direction R1 about an axis of the lower hinge shaft 24.

The shaft support portions 22a, 22b of the link plate 22 are formed such that a width between outer ends of the shaft support portions 22a, 22b in the left-and-right direction is slightly larger than a width between inner ends of the shaft support portions 21a, 21b of the fixing portion 21 in the left-and-right direction. The width between the outer ends of the shaft support portions 22a, 22b in the left-and-right direction is a width in the left-and-right direction between a left end of the left shaft support portion 22a and a right end of the right shaft support portion 22b. Further, the width between the inner ends of the shaft support portions 21a, 21b in the left-and-right direction is a width in the left-and-right direction between a right end of the left shaft support portion 21a and a left end of the right shaft support portion 21b. Accordingly, the shaft support portions 22a, 22b of the link plate 22 are press-fitted when the shaft support portions 22a, 22b are disposed inside, in the left-and-right direction, the shaft support portions 21a, 21b of the fixing portion 21. With such a configuration, a large frictional force is generated between the link plate 22 and the fixing portion 21 during rotation. Due to such a frictional force, the relative rotational position between the link plate 22 and the fixing portion 21 is maintained. That is, a posture of the HMD body 10 relative to the link plate 22 is held. Here, the frictional force generated between the link plate 22 and the fixing portion 21 produces a frictional force with which the rotational position does not change due to vibrations caused by normal working operations such as walking, head shaking, or the like of the user U. That is, such a frictional force is set to an extend that the link plate 22 can be rotated relative to the fixing portion 21 when the user U intentionally applies a force in order to change the posture of the HMD body 10.

On the other end of the link plate 22 in the longitudinal direction L, a pair of left and right shaft support portions 22c, 22d is formed. The shaft support portions 22c, 22d are formed in the same manner as the shaft support portions 22a, 22b on one end side, except for a point that the shaft support portions 22c, 22d protrude toward the other end side in the longitudinal direction L with respect to the link plate 22. An upper hinge shaft 25 extending in the left-and-right direction is supported on the shaft support portions 22c, 22d. A U-shaped clip plate 23 is supported on the upper hinge shaft 25 in a rotatable manner about the upper hinge shaft 25. The upper hinge shaft 25 corresponds to an example of the second rotary shaft.

As illustrated in FIG. 4, the clip plate 23 is formed of a plate having a U shape in which a front side is closed and a rear side is open. The clip plate 23 has a base portion 23a on a front side of the curved shape, a lower surface portion 23b extending rearward from a lower end of the base portion 23a, and an upper surface portion 23c extending rearward from an upper end of the base portion 23a. The upper surface portion 23c is formed shorter than the lower surface portion 23b. The lower surface portion 23b corresponds to an example of the second side portion. The upper surface portion 23c corresponds to an example of the first side portion.

As illustrated in FIG. 1, a pair of left and right shaft support portions 23d, 23e protruding downward is formed on a lower surface of the lower surface portion 23b. As illustrated in FIG. 4, the shaft support portions 23d, 23e are formed on a front side of the center portion, in the fore-and-aft direction, of the lower surface portion 23b. A through holes is formed in the shaft support portions 23d, 23e in a penetrating manner in the left-and-right direction, and the upper hinge shaft 25 extending in the left-and-right direction is inserted through the through holes. With such a configuration, the clip plate 23 rotates in a rotational direction R2 about an axis of the upper hinge shaft 25. The shaft support portions 23d, 23e are formed such that a width between inner ends of the shaft support portions 23d, 23e in the left-and-right direction is smaller than a width between outer ends of the shaft support portions 22c, 22d of the link plate 22 in the left-and-right direction, and the shaft support portions 22c, 22d of the link plate 22 are press-fitted between the shaft support portions 23d, 23e of the clip plate 23. With such a configuration, such a frictional force is set to an extent that the link plate 22 can be rotated relative to the clip plate 23 when the user U intentionally applies a force in order to change the posture of the HMD body 10.

A sheet-like slip stopper 26 extending in the fore-and-aft direction is provided on an inner surface of the lower surface portion 23b. The slip stopper 26 is a rubber sheet, for example. As viewed in side view, the slip stopper 26 extends from a front side of the shaft support portions 23d, 23e to a rear end of the upper surface portion 23c.

As illustrated in FIG. 4, through holes 23f and 23g extending in the vertical direction are formed in the upper surface portion 23c. The through holes 23f and 23g are provided in pair in the fore-and-aft direction. The front through hole 23f is formed corresponding to positions of the shaft support portions 23d, 23e. In the present embodiment, the front through hole 23f is formed slightly in front of the shaft support portions 23d, 23e, and is formed behind a front end 26a of the rubber sheet 26. The rear through hole 23g is formed corresponding to a rear end portion of the rubber sheet 26, and is formed in front of a rear end 26b of the rubber sheet 26. In the through holes 23f, 23g, female threads 23f1, 23g1 are formed.

In the through holes 23f, 23g, knobs 27, 28, as an example of the protrusion, are disposed in a state where the knobs 27, 28 are fixed to the through holes 23f, 23g by threaded engagement respectively. The knobs 27, 28 have circular cylindrical knob bodies 27a, 28a, and threaded portions 27b, 28b fixed to the knob bodies 27a, 28a, respectively. By pinching and rotating the knob bodies 27a, 28a, the knobs 27, 28 are threadedly engaged into the upper surface portion 23c, or loosened. On distal ends of the threaded portions 27b, 28b, caps 27c, 28c are fixedly mounted. The caps 27c, 28c are made of rubber or a resin.

The clip plate 23 is attached to a front portion of the helmet 50. A brim portion 51 on a front portion of the helmet 50 is suitable for the portion to which the clip plate 23 is to be attached. The clip plate 23 is mounted on the brim portion 51 so as to clamp the brim portion 51. The lower surface portion 23b of the clip plate 23 is disposed below the brim portion 51. The upper surface portion 23c of the clip plate 23 is disposed above the brim portion 51. Here, the slip stopper 26 of the lower surface portion 23b can be brought into contact with a lower surface of the brim portion 51.

In this state, by rotating the knobs 27, 28, the knobs 27, 28 are threadedly engaged into the upper surface portion 23c, and a distance between the threaded portions 27b, 28b and the lower surface portion 23b is narrowed. Further, by rotating the knobs 27, 28, the brim portion 51 is sandwiched between the threaded portions 27b, 28b and the lower surface portion 23b, and the clip plate 23 is fixed to the helmet 50. That is, the HMD body 10 is attached to the helmet 50 by way of the attachment 20. Since the threaded portions 27b, 28b press the helmet 50 by way of the caps 27c, 28c, it is possible to prevent the helmet 50 from being locally excessively pressed. Further, since the threaded portions 27b, 28b press an inner side of the rubber sheet 26, the lower surface of the brim portion 51 is easily pressed to the rubber sheet 26 so that the attachment 20 is less likely to slip.

Here, in the present embodiment, since the caps 27c, 28c each have a diameter larger than diameters of the through holes 23f, 23g, the caps 27c, 28c also have a function of preventing the knobs 27, 28 from being removed from the upper surface portion 23c.

1-2. Method of Using Head-Mounted Display

An example of an operation of attaching the head-mounted display 1 to the helmet 50 is described. When the user U attaches the head-mounted display 1 to the helmet 50, the user U places the clip plate 23 at the center portion of the brim portion 51 of the helmet 50 in the left-and-right direction. In the clip plate 23, the shaft support portions 23d, 23e to which a load from the HMD body 10 is applied are formed on a front side of the center portion of the lower surface portion 23b in the fore-and-aft direction and hence, the load of the HMD body 10 is easily applied to the front side of the lower surface portion 23b. Then, when the clip plate 23 is pulled downward at a front side thereof, the upper surface portion 23c of the clip plate 23 is easily supported on the brim portion 51 at a front side thereof, and a rear side of the lower surface portion 23b is easily moved upward. Since the lower surface portion 23b is longer than the upper surface portion 23c in a rearward direction, the rear side of the lower surface portion 23b is easily pressed to the brim portion 51 so that the slip stopper 26 is easily brought into contact with the brim portion 51. Accordingly, removal of the clip plate 23 at the time of temporarily attaching the clip plate 23 can be easily prevented.

When the knobs 27, 28 are rotated in a state where the clip plate 23 is disposed on the brim portion 51, the clip plate 23 is fixed to the brim portion 51. Then, by rotating and fixing the rear-side knob 28 first and by fixing the front-side knob 27, the clip plate 23 can be easily fixed to the helmet 50 while suppressing the rotation of the head-mounted display 1 about the threaded portion 28b of the knob 28, that is, a so-called lateral swing of the head-mounted display 1.

Particularly, in the present embodiment, a configuration is adopted in which one clip plate 23 extending linearly while having a U shape is disposed on the brim portion 51. Accordingly, as illustrated in FIG. 1, when the center portion of the brim portion 51 in the left-and-right direction is curved in a mountain shape, the lower surface portion 23b and the upper surface portion 23c are easily disposed along a top portion 51a at the center portion of the brim portion 51 in the left-and-right direction so as to clamp the top portion 51a therebetween and hence, positioning of the clip plate 23 with respect to the brim portion 51 can be easily performed.

In a state where the clip plate 23 is attached to the brim portion 51, the helmet 50 is properly mounted to the head U1. When the helmet 50 is properly mounted, the HMD body 10 is made to approach the face of the user U such that the left light-guiding plate 12 of the HMD body 10 is positioned in front of the left eye of the user U and the right light-guiding plate 13 of the HMD body 10 is positioned in front of the right eye of the user U by rotating the link plate 22. Then, the attachment 20 is rotatable about two portions, that is, the lower hinge shaft 24 and the upper hinge shaft 25. Accordingly, compared to a case where the HMD body 10 is rotated about one position, the position of the HMD body 10 can be easily adjusted corresponding to an inclination angle of the brim portion 51 of the helmet 50, a height position of the helmet 50, and height positions of the eyes of the user U.

Particularly, when the nose pads 18, 19 are mounted on the HMD body 10, positioning of the HMD body 10 can be easily performed by rotating the HMD body 10 to an extent that the nose pads 18, 19 are brought into contact with the nose U2 of the user U.

When the HMD body 10 is adjusted in angle or position so as to be arranged at a position suitable for the user U, the user U uses the head-mounted display 1 at the work site. In general, since the user U walks or works while shaking his/her head, force from various directions acts on the helmet 50 and the head-mounted display 1.

Here, in the related art, the head-mounted display fixed to the helmet 50 adjusts in posture relative to the helmet 50 by a ball joint mechanism. In the ball joint mechanism, the head-mounted display is easily adjusted in position in various directions after the head-mounted display is attached to the helmet 50. However, on the other hand, the position of the head-mounted display is easily moved in various directions because of the configuration of the ball joint mechanism. Accordingly, when the head-mounted display is used, there is a concern that the position of the head-mounted display is easily displaced in position due to various impacts.

On the other hand, the attachment 20 according to the present embodiment adopts the configuration in which, after the clip plate 23 is fixed to the helmet 50, the attachment 20 is rotated only in the rotational directions R1, R2 about axes of the hinge shafts 24, 25 extending in the left-and-right direction. Accordingly, even when a rotational moment about a rotation axis extending in the vertical direction or a rotational movement about a rotation axis extending in the fore-and-aft direction are applied to the head-mounted display 1, the position of the head-mounted display 1 is minimally displaced.

In the first place, the helmet 50 itself is not also completely fixed to the head U1, and the movement of the helmet 50 relative to the head U1 is allowed to some extent. Accordingly, when the head-mounted display 1 is attached to the helmet 50 or the like, the position of the HMD body 10 can also be adjusted by moving the helmet 50 relative to the head U1.

Therefore, in the present embodiment, the necessary and sufficient adjustment can be performed with respect to a posture of the HDM body 10 attached to the helmet 50 while simplifying the angular adjustment by omitting the excessive angular adjustment.

As has been described above, in the present embodiment, the attachment 20 is an attachment 20 that is configured to attach the HMD body 10 displaying an image to the helmet 50 to be mounted on the head U1. The attachment 20 has the link plate 22 that supports the HMD body 10 in a predetermined posture, and the clip plate 23 that attaches the link plate 22 to the helmet 50. The link plate 22 has the lower hinge shaft 24 having a rotation axis thereof in the left-and-right direction as an example of the first direction, and the upper hinge shaft 25 having a rotation axis thereof in the left-and-right direction. The link plate 22 supports the HMD body 10, in a predetermined posture, in a rotatable manner in the rotational direction R1 about the axis of the lower hinge shaft 24, and is supported by the clip plate 23, in a predetermined posture, in a rotatable manner in the rotation direction R2 about the axis of the upper hinge shaft 25. Accordingly, after the clip plate 23 is attached to the helmet 50, the position of the HMD body 10 can be adjusted by rotating the link plate 22 in the rotational directions R1, R2 about the axes of the upper and lower hinge shafts 25, 24 extending in the left-and-right direction. Further, unnecessary adjustments such as a rotation in a direction other than the rotational directions R1, R2 about the axes of the upper and lower hinge shafts 25, 24 extending in the left-and-right direction can be omitted. Accordingly, the necessary and sufficient positional adjustment can be performed with respect to the HMD body 10 attached to the helmet 50.

In the attachment 20 of the present embodiment, the clip plate 23 includes the upper surface portion 23c disposed on the upper side as an example of the first side of the helmet 50, and the lower surface portion 23b disposed adjacent to the upper surface portion 23c and disposed on the lower side as an example of the second side of the helmet 50. In the clip plate 23, two or more protrusions 27, 28 that protrude from the upper surface portion 23c toward the lower surface portion 23b so as to press the helmet 50 are provided on the upper surface portion 23c. Accordingly, when the helmet 50 is pressed at a point of the protrusion, there is a case in which the clip plate 23 is rotated about the pressing point. However, in the present embodiment, the helmet 50 is pressed by the clip plate 23 at two or more points and hence, it is possible to prevent the clip plate 23 from being rotated about the pressing points of the protrusions 27, 28.

Further, in the attachment 20 of the present embodiment, the protrusions 27, 28 are formed of the knobs 27, 28 having the threaded portions 27b, 28b respectively. Accordingly, an amount of pressing force can be adjusted by adjusting an amount of rotation of the knobs 27, 28, and an attachment position of the clip plate 23 can be easily adjusted by adjusting an amount of a pressing force for each of the knobs 27, 28.

Further, as described above, the head-mounted display 1 of the present embodiment includes the HMD body 10 that is configured to display an image, and the attachment 20 that is configured to attach the HMD body 10 to the helmet 50 to be mounted on the head U1. Accordingly, after the clip plate 23 is attached to the helmet 50, the position of the HMD body 10 can be adjusted by rotating the link plate 22 in the rotational directions R1, R2 about the axes of the upper and lower hinge shafts 25, 24 extending in the left-and-right direction. Further, unnecessary adjustments such as a rotation in a direction other than the rotational directions R1, R2 about the axes of the upper and lower hinge shafts 25, 24 extending in the left-and-right direction can be omitted. Accordingly, the necessary and sufficient positional adjustment can be performed with respect to the HMD body 10 attached to the helmet 50.

In the head-mounted display 1 of the present embodiment, the nose pads 18, 19 are attached to the HMD body 10. Accordingly, the position of the head-mounted display 1 can be adjusted using the nose pads 18, 19 as a guide.

Further, in the head-mounted display 1 of the present embodiment, the HMD body 10 includes the left light-guiding plate 12 that displays an image for the left eye as an example of the first image, and the right light-guiding plate 13 that displays an image for the right eye as an example of the second image. Further, the HMD body 10 includes the frame 11 for fixing the left light-guiding plate 12 and the right light-guiding plate 13. In the HMD body 10, the link plate 22 is attached to the frame 11 between the left light-guiding plate 12 and the right light-guiding plate 13. Accordingly, the link plate 22 supports the HMD body 10 between the left light-guiding plate 12 and the right light-guiding plate 13 and hence, the HMD body 10 can be supported in a well-balanced manner.

In the head-mounted display 1 of the present embodiment, the clip plate 23 is disposed between the left light-guiding plate 12 and the right light-guiding plate 13, and two or more knobs 27, 28 are disposed on a straight line on the upper surface portion 23c. Accordingly, by disposing the knobs 27, 28 on a straight line, the clip plate 23 can be attached to the curved surface of the helmet 50.

### 2. Second Embodiment

2-1. Configuration of Head-Mounted Display

Next, a second embodiment of the present disclosure is described. Here, components identical with the components of the first embodiment are given the same symbols, and their repeated description is omitted.

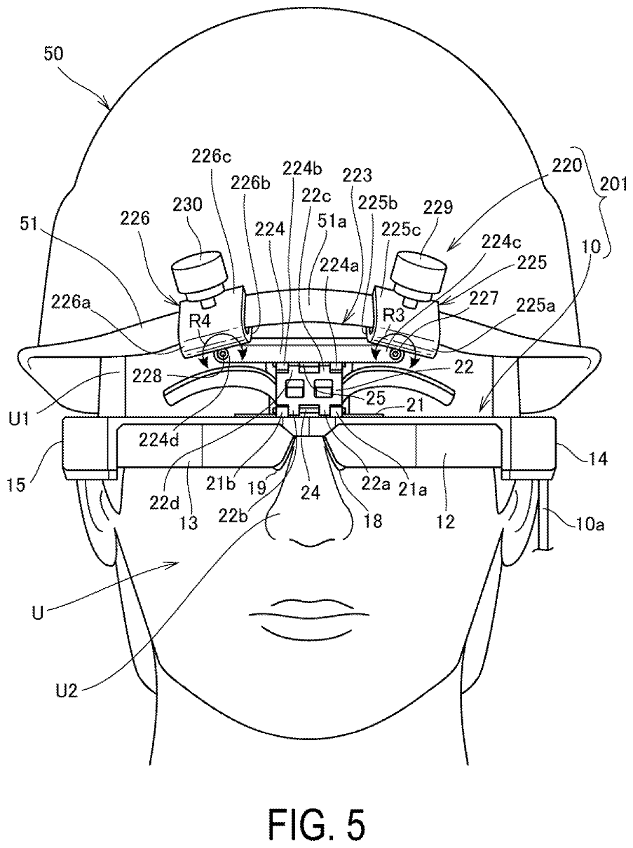

FIG. 5 is a front view illustrating an in-use state of a head-mounted display 201 according to the second embodiment.

The head-mounted display 201 of the second embodiment includes an attachment 220 in place of the attachment 20.

2-1-2. Configuration of Attachment

In the attachment 220 of the second embodiment, an attachment unit 223 is rotatably supported by an upper portion of a link plate 22 in place of the clip plate 23.

The attachment unit 223 includes an elongated-plate-like stay 224 extending in the left-and-right direction, and clip plates 225, 226, as an example of the attachment unit, that is supported on both left and right ends of the stay 224.

The stay 224 corresponds to an example of the extending member. On a lower surface of the stay 224, a pair of left and right shaft support portions 224a, 224b protruding downward is formed. The shaft support portions 224a, 224b are configured in the same manner as the shaft support portions 23d, 23e of the clip plate 23. Shaft support portions 22c, 22d of the link plate 22 are press-fitted between the shaft support portions 224a, 224b, and an upper hinge shaft 25 is inserted through the respective shaft support portions 22c, 22d, and 224a, 224b. With such a configuration, an angle of the stay 224, that is, an angle of the attachment unit 223 is adjusted due to a frictional force in a rotation direction R2 about an axis of the upper hinge shaft 25 with respect to the link plate 22.

A pair of front and rear shaft support portions 224c is formed on a left end of the stay 224. A rotary shaft 227 extending in the fore-and-aft direction is supported by the shaft support portions 224c. A left clip plate 225, as an example of the first attachment unit, is supported on the rotary shaft 227 in a rotatable manner about the rotary shaft 227.

The left clip plate 225 has a U shape in which a front side is closed and a rear side is open. The left clip plate 225 is configured to correspond to the clip plate 23. That is, the left clip plate 225 includes a base portion 225a having a curved shape disposed on a front side, a lower surface portion 225b extending rearward from a lower end of the base portion 225a, and an upper surface portion 225c extending rearward from an upper end of the base portion 225a. A shaft support portion, not illustrated in the drawing, protruding downward is formed on a lower surface of the lower surface portion 225b. The shaft support portion not illustrated in the drawing is disposed between the pair of front and rear shaft support portions 224c of the stay 224, and the rotary shaft 227 is inserted therethrough. With such a configuration, the left clip plate 225 is rotatably supported in a rotational direction R3 about an axis of the rotary shaft 227. A knob 229 is provided to the left clip plate 225. The knob 229 is configured in the same manner as the knobs 27, 28.

The left clip plate 225 is configured in the same manner as the clip plate 23 except for the above-described configurations.

A pair of front and rear right shaft support portions 224d is formed on a right end of the stay 224. A rotary shaft 228 extending in the fore-and-aft direction is supported on the right shaft support portions 224d. The right clip plate 226, as an example of the second attachment unit, is supported on the rotary shaft 228 in a rotatable manner about the rotary shaft 228. The right clip plate 226 is rotatably supported in a rotational direction R4 about an axis of the rotary shaft 228. The right clip plate 226 is disposed in left-right symmetry with the left clip plate 225. The right clip plate 226 has a base portion 226a, a lower surface portion 226b, and an upper surface portion 226c. A knob 230 is provided to the right clip plate 226.

2-1. Operation in Using Head-Mounted Display

An example of an operation of attaching the head-mounted display 201 is described. When the user U attaches the head-mounted display 201 to a helmet 50, the left clip plate 225 is attached to a left portion of a brim portion 51 of the helmet 50. Further, the right clip plate 226 is attached to a right portion of the brim portion 51 of the helmet 50. The clip plates 225, 226 are disposed in left-right symmetry with respect to a top portion 51a of the brim portion 51.

In the present embodiment, the left and right clip plates 225, 226 are rotatable in the rotational directions R3, R4 about axes of the rotary shafts 227, 228 extending in the fore-and-aft direction respectively. Accordingly, the clip plates 225, 226 are easily fitted on the brim portion 51 in conformity with an inclination of the brim portion 51, and the clip plates 225, 226 can be fixed to the brim portion 51 by the respective knobs 229, 230. Therefore, also in the present embodiment, even when the brim portion 51 is curved in a mountain shape, the clip plates 225, 226 can be easily attached to the brim portion 51 by the lower surface portions 225b, 226b and the upper surface portions 225c, 226c.

As has been described above, in the present embodiment, the attachment 220 is an attachment 220 that is configured to attach the HMD body 10 displaying an image to the helmet 50 to be mounted on the head U1. The attachment 220 includes the link plate 22 that is configured to support the HMD body 10 in a predetermined posture, and the attachment unit 223 that is configured to attach the link plate 22 to the helmet 50. The link plate 22 includes the lower hinge shaft 24 having the rotation axis thereof in the left-and-right direction, and the upper hinge shaft 25 having the rotation axis thereof in the left-and-right direction. The link plate 22 supports the HMD body 10, in a predetermined posture, in a rotatable manner in the rotational direction R1 about the axis of the lower hinge shaft 24, and is supported by the attachment 223, in a predetermined posture, in a rotatably manner in the rotational direction R2 about the axis of the upper hinge shaft 25. Accordingly, after the attachment unit 223 is attached to the helmet 50, the position of the HMD body 10 can be adjusted by rotating the link plate 22 in the rotational directions R1, R2 about the axes of the upper and lower hinge shafts 25, 24 extending in the left-and-right direction. Further, unnecessary adjustments such as a rotation in a direction other than the rotational directions R1, R2 about the axes of the upper and lower hinge shafts 25, 24 extending in the left-and-right direction can be omitted. Accordingly, the necessary and sufficient positional adjustment can be performed with respect to the HMD body 10 attached to the helmet 50.

In the head-mounted display 201 of the present embodiment, the attachment unit 223 includes the stay 224 that extends in the left-and-right direction and is supported by the link plate 22, the left clip plate 225 that is supported at one end of the stay 224, and the right clip plate 226 that is supported at the other end of the stay 224. The left clip plate 225 and the right clip plate 226 each have the upper surface portions 225c, 226c and the lower surface portions 225b, 226b respectively. Accordingly, the left clip plate 225 and the right clip plate 226 can be attached to the helmet 50 in a spaced apart manner in the left-and-right direction.

The above-described embodiments are merely the specific modes for carrying out the present disclosure described in the claims, and are not intended to limit the present disclosure. For example, the present disclosure can be implemented in various modes without departing from the gist of the present disclosure as described below.

In the above-described embodiments, the description has been made with respect to the configurations in which the link plate 22 is press-fitted to the fixing portion 21, the clip plate 23, and the attachment unit 223 so that a frictional force is generated when the link plate 22 is rotated. However, for example, a frictional force may be generated by press-fitting the hinge shafts 24, 25 by threaded engagement.

In the above-described embodiments, the description is has been made with respect to the configuration in which head-mounted display 1 is fixed to the helmet 50 as an example of the object. However, a configuration may be provided in which the head-mounted display 1 is fixed to an object to be mounted on a head having a brim portion such as a sun visor.

In the above-described embodiment, the description has been made with respect to a configuration in which the HMD body 10 is wired to the controller not illustrated in the drawing by way of the cable 10a. However, in place of the wired coupling, wireless coupling may be adopted. For example, the cable 10a extending from the HMD body 10 may be omitted, and the HMD body 10 and the controller may be coupled to each other via wireless communication.

What is claimed is:

1. An attachment comprising:
a support member that supports a display unit of a head-mounted display and that includes a first rotary shaft with a first direction as rotation axis and a second rotary shaft with the first direction as rotation axis; and
an attachment unit that attaches the support member to an object, wherein
the support member is configured to rotatably support the display unit by an axis of the first rotary shaft, and
the support member is configured to rotatably support the attachment unit by an axis of the second rotary shaft.

2. The attachment according to claim 1, wherein
the attachment unit includes:
a first side portion disposed on a first side of the object, and
a second side portion disposed on a second side of the object opposite to the first side of the object, and
the first side portion includes a protrusion that protrudes from the first side portion toward the second side portion.

3. The attachment according to claim 2, wherein
the protrusion is a knob having a threaded portion.

4. A head-mounted display comprising:
a display that displays an image;
a support member that includes:
a first rotary shaft with a first direction as rotation axis, and
a second rotary shaft with the first direction as rotation axis; and
an attachment unit that attaches the support member to an object, wherein
the support member is configured to rotatably support the display unit by an axis of the first rotary shaft, and
the support member is configured to rotatably support the attachment unit by an axis of the second rotary shaft.

5. The head-mounted display according to claim 4, wherein
a nose pad is attached to the display unit.

6. The head-mounted display according to claim 4, wherein
the display unit includes:
a first display unit that displays a first image;
a second display unit that displays a second image; and
a fixing member that is disposed between the first display unit and the second display unit and that fixes a position of the first display unit with respect to a position of the second display unit, and
the support member is attached to the fixing member.

7. The head-mounted display according to claim 6, wherein
the attachment unit is disposed between the first display unit and the second display unit.

8. The head-mounted display according to claim 6, wherein
the attachment unit includes:
an extending member that extends in the first direction and that is supported by the support member;
a first attachment unit that is supported at one end of the extending member; and
a second attachment unit that is supported at the other end of the extending member, and
each of the first attachment unit and the second attachment unit includes:
a first side portion that is disposed on a first side of the object; and
a second side portion that is disposed on a second side of the object that is a side opposite to the first side of the object.
